(19) United States
(12) Patent Application Publication
(10) Pub. No.: US 2013/0212629 A1
(43) Pub. Date: Aug. 15, 2013

(54) TELEVISION SYSTEM OPERATED WITH REMOTE TOUCH CONTROL

(71) Applicant: Li TV Taiwan Inc., (US)

(72) Inventors: Ta-Wei CHIEN, Taipei City (TW); Michael Ken MINAKAMI, Mountain View, CA (US); Der Hong YANG, Taipei City (TW)

(73) Assignee: Li TV Taiwan Inc., Taipei City (TW)

(21) Appl. No.: 13/758,952

(22) Filed: Feb. 4, 2013

(30) Foreign Application Priority Data
Feb. 15, 2012 (TW) 101104880

(51) Int. Cl. H04N 21/482

(52) U.S. Cl. CPC H04N 21/482
USPC 725/61

(57) ABSTRACT

A television system comprises a remote touch-controlled device and a television receiver apparatus. A graphical user interface (GUI) is run on the touch-controlled device to provide a display that matches at least partially with the display of the GUI run on the television receiver apparatus. A user can thereby intuitively manipulates the touch-controlled device assisted by its GUI to remotely control the operation of the television receiver apparatus.

### BACKGROUND OF THE INVENTION

1. Field of the Invention

The present inventions relate to television systems, and more particularly, to a television system operable by a user with a remote touch-controlled device to perform a television application instruction.

2. Description of the Prior Art

With technological advancement of television systems, people nowadays have access to ever-increasing information services, such as webpage browsing, information display, multimedia playing, games, and application software through a television system.

However, even though a typical television system is multifunctional, its remote controller is still its sole input device to the detriment of ease of use. Some known applications propose to use a keyboard and a mouse for operating the television system. Some television sets may be also provided with tactile display screens to allow touch control, which usually requires higher cost and does not permit remote control.

Accordingly, there is a need for a remote control method that allows a user to control a multifunction television system in an easy way.

### SUMMARY

Ease of use of a multifunction television system will be enhanced, if users can intuitively send a control signal to the multifunction television system from a remote controller.

According to one aspect, a television system described herein can be operated via a remote touch control.

According to another aspect, a television system described herein comprises a television receiver apparatus and a touch-controlled device. A graphical user interface (GUI) is run on the touch-controlled device to provide a display that matches another GUI displayed on the television receiver apparatus.

In an embodiment, the television system comprises a television receiver apparatus and a touch-controlled device. The television receiver apparatus comprises: a television signal receiving unit for receiving a television signal containing television programs; a first driver running a first GUI; a first transceiver for receiving a control signal and transmitting an updating signal; and a processor for generating the updating signal, and performing a television application instruction provided by the first GUI in response to the control signal. The touch-controlled device comprises: a second driver for running a second GUI; a touch display unit for displaying the second GUI, and generating the control signal in response to a user's touch input to the touch-controlled device via the second GUI; and a second transceiver for receiving the updating signal and transmitting the control signal, wherein the second driver updates objects displayed by the second GUI to match with certain objects displayed by the first GUI according to the updating signal.

### BRIEF DESCRIPTION OF THE DRAWINGS

FIG. 1 is a schematic diagram showing an embodiment of a television system;

FIG. 2 is a schematic diagram showing exemplary operation of the television system;

FIG. 3A through FIG. 3F are schematic diagrams showing various graphical representations of matching objects between two GUIs; and

FIG. 4 is a simplified block diagram showing an example of hardware configuration for the television system.

### DETAILED DESCRIPTION OF THE EMBODIMENTS

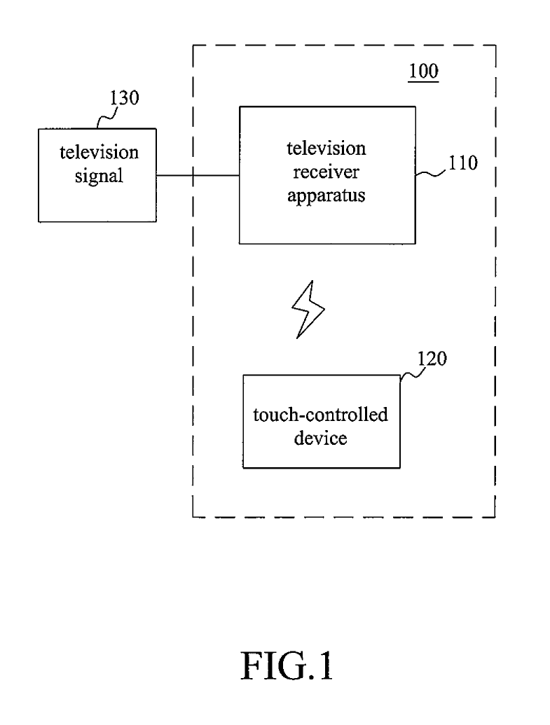

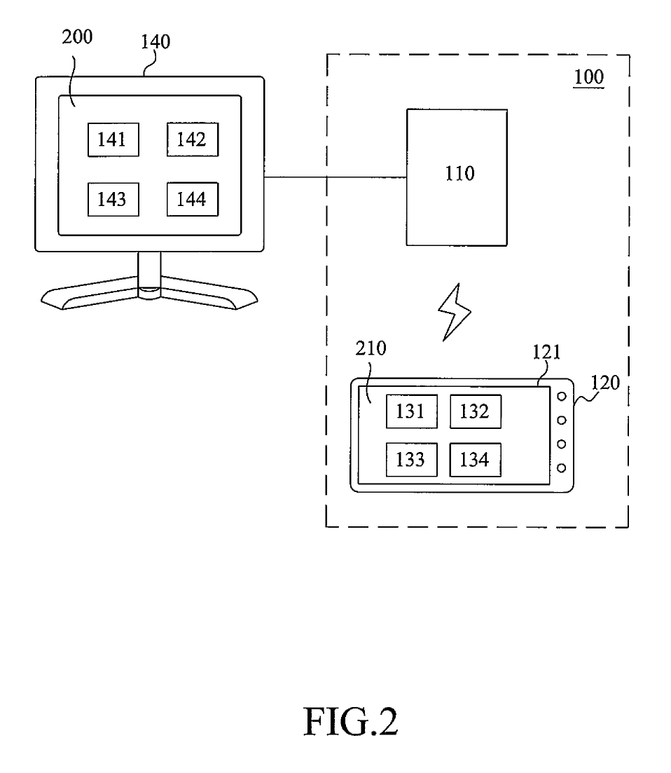

FIG. 1 is a simplified diagram showing a television system 100. The television system 100 comprises a television receiver apparatus 110 and a touch-controlled device 120. The television receiver apparatus 110 can run a first graphical user interface (a first GUI) for display on a television screen (not shown). The touch-controlled device 120 can receive an updating signal from the television receiver apparatus 110, update a second graphical user interface (a second GUI) (not shown) to match with the first GUI, and display the updated second GUI on a screen of the touch-controlled device 120. Objects that are displayed by the second GUI can match with objects displayed by the first GUI. More details are described below in conjunction with FIG. 2 through FIG. 4.

The television receiver apparatus 110 can receive a television signal 130 containing television programs. The television signal 130 can be transmitted through a cable or via wireless transmission. The television signal 130 may originate from a satellite signal source, a wired signal source, a wireless signal source, or an Internet Protocol television (IPTV) signal source.

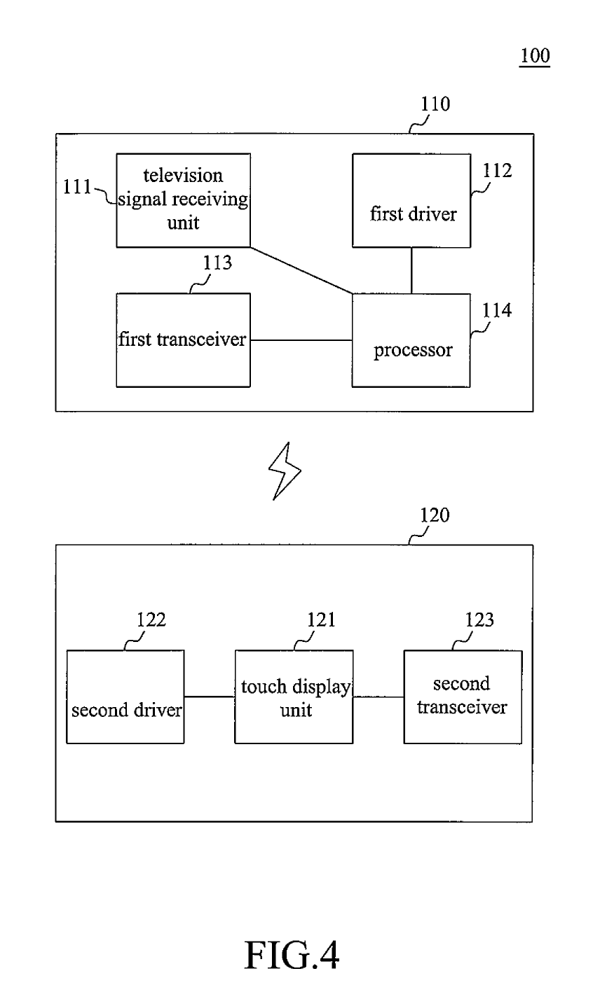

A tuner or a decoder (not shown) is built in the television receiver apparatus 110 for processing the television signal. The television receiver apparatus 110 can be an information-processing device such as a set-top box, which is independent from a television set (not shown). In alternate embodiments, the television receiver apparatus 110 may also be integrated into the television set, in part or in whole. For instance, the television receiver apparatus 110 can comprise a television signal receiving unit (not shown) installed outside the television set, and comprises other functional units installed inside the television set. Examples of functional units in the television receiver apparatus 110 are depicted in FIG. 4 and described below.

The touch-controlled device 120 is a touch display device, and comprises a touch panel and a display. Examples of the touch-controlled device 120 include a smartphone with a tactile display screen, and a tablet computer. Alternatively, the touch-controlled device 120 may be a controller device with a tactile display screen capable of transmitting a control signal.

FIG. 2 is a diagram showing exemplary operation of the television system 100. The described television receiver apparatus 110 is exemplary a set-top box connected to a television set 140. The screen of the television set 140 can display a first GUI 200 (hereinafter referred to as a television GUI) run on the television receiver apparatus 110. The television GUI 200 displays a plurality of objects 141, 142, 143, 144 each associated with a television application instruction, an application program, or a multimedia file. In one example, the objects 141-144 may be associated with a switch power instruction, a channel selection instruction, a volume tuning instruction, and a mute instruction, respectively. In another example, the objects 141-144 may be associated with a meteorological application, an instant messaging application, a media playing application, and a news application, respectively. In yet another example, the objects 141-144 may be associated with four different available movies, respectively, wherein each of the objects bears an icon representative of a movie presented for selection. In another example, the objects 141-144 may be associated with a fast forward instruction, a rewind instruction, a pause instruction, and a play instruction for a multimedia file, respectively.

The touch-controlled device 120 comprises a touch display unit 121. The touch display unit 121 displays a second GUI 210 (hereinafter referred to as a touch-controlled GUI). In this embodiment, the touch-controlled device 120 is a smartphone having a tactile display screen (that is, the touch display unit 121). The touch-controlled GUI 210 displays objects which match objects displayed on the television GUI 200.

More specifically, objects are displayed by the touch-controlled GUI 210 in a way that allows a user to easily find matching between objects displayed by the touch-controlled GUI 210 and objects displayed by the television GUI 200. More details are described below. Accordingly, the user can apply control via the touch-controlled GUI 210 so as to generate a control signal, such that the television receiver apparatus 110 performs a television application instruction provided by the television GUI 200 in response to the control signal.

Referring to FIG. 2, the objects 131-134 displayed by the touch-controlled GUI 210 on the touch-controlled device 120 match with the objects 141-144 displayed by the television GUI 200. The television GUI 200 is run by the television receiver apparatus 110 for display on the screen of the television set 140. However, the television GUI 200 can also be provided by the television receiver apparatus 110 and displayed on any other type of displays.

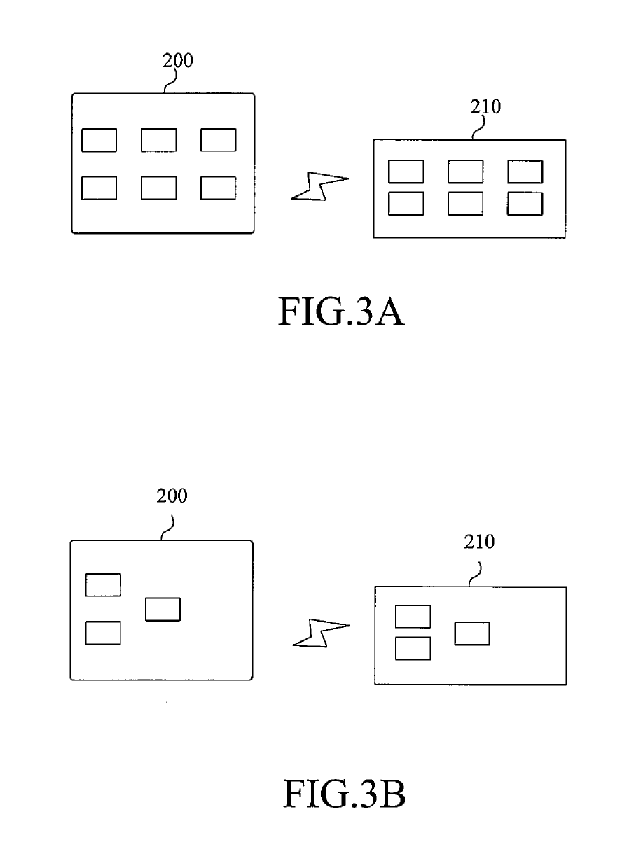

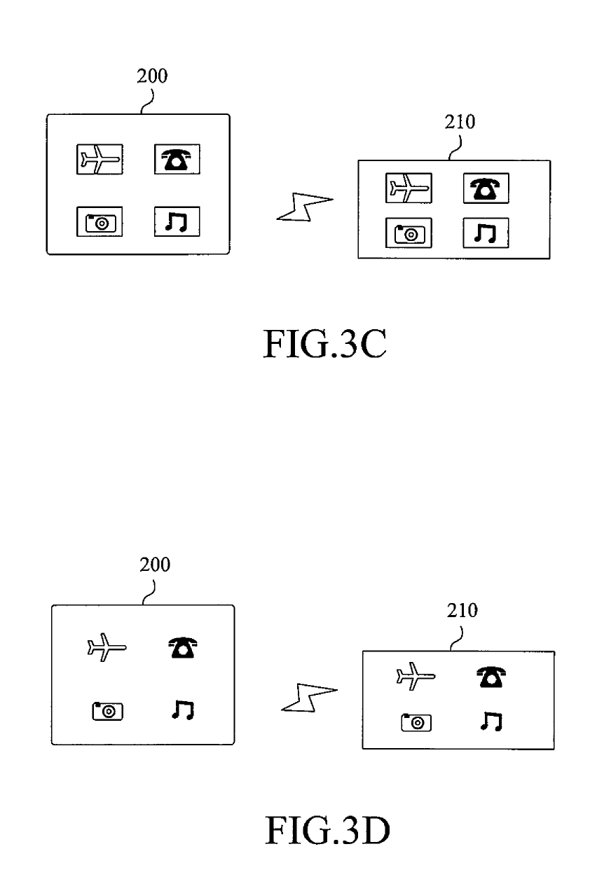

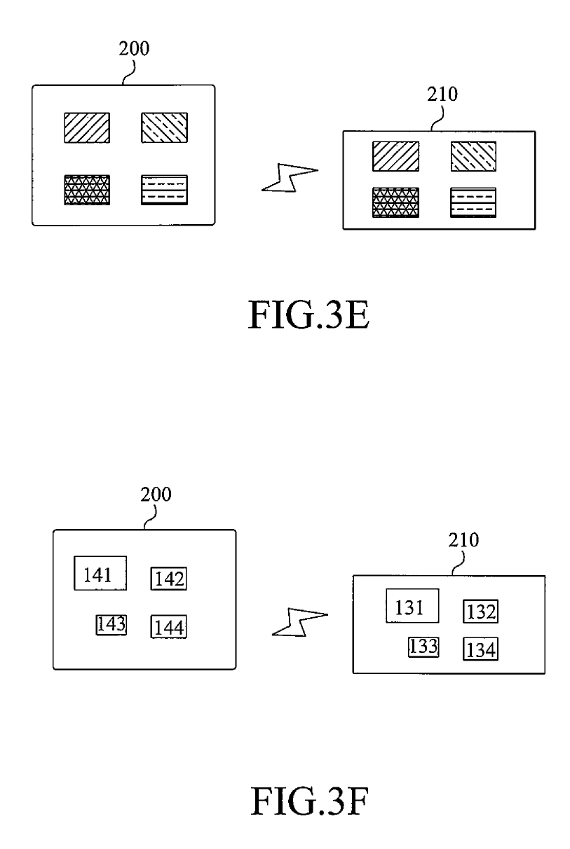

To allow the user to easily find correspondence between objects displayed by the touch-controlled GUI 210 and objects displayed by the television GUI 200, the objects can be displayed on the touch-controlled device 120 according to any of the graphical representations shown in FIG. 3A through FIG. 3F, or a combination thereof. Alternatively, the displayed touch-controlled GUI 210 and the television GUI 200 may be identical. Referring to FIG. 3A through FIG. 3F, the graphical representation can be as follows.

The amount of objects displayed by the touch-controlled GUI 210 can correspond to the amount of objects displayed by the television GUI 200. For example, referring to FIG. 3A, the television GUI 200 has six objects, and the touch-controlled GUI 210 also has six objects.

The objects displayed by the touch-controlled GUI 210 can correspond in position to the objects displayed by the television GUI 200. For example, referring to FIG. 3B, the television GUI 200 displays three objects, namely two objects on the left and one object at the middle. Likewise, the touch-controlled GUI 210 can display three objects, two objects on the left and one object at the middle.

The icons of the objects displayed by the touch-controlled GUI 210 can be similar to the icons of the objects displayed by the television GUI 200. For example, referring to FIG. 3C, assume that the television GUI 200 displays four objects with identical frames, namely the object positioned at the upper left corner that is represented by an icon of an airplane, the object positioned at the upper right corner that is represented by an icon of a telephone, the object positioned at the lower left corner that is represented by an icon of a camera, and the object positioned at the lower right corner that is represented by an icon of a musical note. Likewise, he touch-controlled GUI 210 also displays four objects represented by icons of an airplane, a telephone, a camera, and a musical note, respectively. Alternatively, for example, referring to FIG. 3D, the television GUI 200 displays four frameless objects, namely the object positioned at the upper left corner represented by an icon of an airplane, the object positioned at the upper right corner that is represented by an icon of a telephone, the object positioned at the lower left corner that is represented by an icon of a camera, and the object positioned at the lower right corner that is represented by an icon of a musical note. Likewise, the touch-controlled GUI 210 also displays four frameless objects represented by icons of an airplane, a telephone, a camera, and a musical note, respectively.

The color of the objects displayed by the touch-controlled GUI 210 can match with the color of the objects displayed by the television GUI 200. For example, referring to FIG. 3E, the television GUI 200 displays four objects in different colors, and thus the touch-controlled GUI 210 also displays four objects in different colors.

The relative sizes of the objects displayed by the touch-controlled GUI 210 can correspond to the objects displayed by the television GUI 200. For example, referring to FIG. 3F, the television GUI 200 displays four objects, namely the object 141 with the largest area, the objects 142, 144 with the same area but less than that of the object 141, and the object 143 with the smallest area. Likewise, the touch-controlled GUI 210 also displays four objects, namely the object 131 with the largest area, the objects 132, 134 with the same area but less than that of the object 131, and the object 133 with the smallest area.

As indicated above, the touch-controlled GUI 210 displays objects that can match objects displayed on the television GUI 200. In response to a user's touch on the touch display unit 121, the touch-controlled device 120 generates a control signal that is transmitted to the television receiver apparatus 110. In response to the control signal, the television receiver apparatus 110 performs a television application instruction provided by the television GUI 200.

The television application instruction can include, without limitation, a switch power instruction, a channel selection instruction, a volume tuning instruction, a signal source switching instruction, a mute instruction, an application program execution instruction, an application program selection instruction, a menu page scrolling instruction, a game execution instruction, an e-book reading instruction, or a fast forward instruction, a rewind instruction, a pause instruction, and a play instruction for a multimedia file. For example, an object of the television GUI 200 can have an icon representing a switch power, an icon representing channel selection, an icon representing a volume tuning function, an icon representing a signal source switching function, an icon representing a muting function, an icon representing an application program, an icon representing a multimedia file, an icon representing a menu page scrolling function, and an icon representing an e-book reading function. The touch-controlled GUI 210 displays objects, which match the objects displayed on the television GUI 200, wherein the objects are indicative of the aforesaid television application instructions, respectively.

Referring to FIG. 2, the television GUI 200 can be run on the television receiver apparatus 110 of the television system 100 for displaying objects. The television receiver apparatus 110 transmits an updating signal to the touch-controlled device 120. The touch-controlled GUI 210 may be run on the touch-controlled device 120 for manipulation by a user. The objects displayed by the touch-controlled GUI 210 can match with the objects displayed by the television GUI 200. The touch-controlled device 120 updates the objects displayed via the touch-controlled GUI 210 according to the updating signal. The touch-controlled device 120 sends a control signal to the television receiver apparatus 110 in response to a user's touch on the screen of the touch-controlled device 120. In response to the control signal, the television receiver apparatus 110 performs a television application instruction displayed via the television GUI 200. The control signal and the updating signal are transmitted between the television receiver apparatus 110 and the touch-controlled device 120 according to any wireless protocol, such as WiFi protocol.

FIG. 4 is a schematic diagram showing an example of hardware configuration for the television system 100. The television receiver apparatus 110 can include a television signal receiving unit 111, a first driver (hereinafter referred to as a television driver) 112, a first transceiver (hereinafter referred to as a television transceiver) 113, and a processor 114. The touch-controlled device 120 can include the touch display unit 121, a second driver (hereinafter referred to as a touch-controlled driver) 122, and a second transceiver (hereinafter referred to as a touch-controlled transceiver) 123.

The television signal receiving unit 111 receives a television signal containing television programs through a cable or via wireless transmission. The television signal may originate from a satellite signal source, a wired signal source, a wireless signal source, or an Internet Protocol television (IPTV) signal source. The television signal receiving unit 111 is a tuner or a decoder. The television driver 112 provides a television GUI (not shown) to be displayed on the screen of a television set (not shown). One or multiple objects can be displayed via the television GUI. For example, the objects can be associated with a television application instruction, an application program, a multimedia file, etc. The first transceiver 113 can receive a control signal from the touch display unit 121, and transmits an updating signal. The processor 114 generates the updating signal, and performs a television application instruction presented for selection by the television GUI in response to the control signal from the television transceiver 113. The television application instructions include, without limitation, a switch power instruction, a channel selection instruction, a volume tuning instruction, a signal source switching instruction, a mute instruction, an application program execution instruction, an application selection instruction, a menu page scrolling instruction, a game execution instruction, an e-book reading instruction, or a fast forward instruction, a rewind instruction, a pause instruction, and a play instruction for a multimedia file.

The touch-controlled GUI (not shown) can be run on the touch-controlled driver 122 of the touch-controlled device 120. The touch display unit 121 displays the touch-controlled GUI, and issues a control signal in response to a user's touch on the screen of the touch-controlled device 120. The touch-controlled transceiver 123 receives the updating signal from the processor 114, and transmits the control signal provided by the touch display unit 121. In response to the updating signal, the touch-controlled driver 122 updates the objects displayed via the touch-controlled GUI to match with objects displayed in the television GUI. In one embodiment, the touch-controlled driver 122 can update the touch-controlled GUI almost at the same time as the television driver 112 updates the television GUI according to the updating signal. Objects displayed via the touch-controlled GUI on the touch-controlled device 120 can thereby always real-time match with the objects displayed in the television GUI.

It will be appreciated that the functional units described in connection with the television receiver apparatus 110 and touch-controlled device 120 have been shown separately for clarity only. In other embodiments, one or more of these functional blocks may also be combined into an integrated unit. Each of these functional units can be selectively implemented in the form of special purpose hardware, software, or a combination thereof.

With the television system 100, the remote touch-controlled device 120 can run a touch-controlled GUI that displays objects matching with objects displayed by a television GUI run on the television receiver apparatus 110. Control of the television receiver apparatus 110 by using the touch-controlled device 120 can be therefore facilitated. A user's touch input to the touch-controlled device 120 via the touch-controlled GUI can have the touch-controlled device 120 generate a control signal. In response to the control signal, the television receiver apparatus 110 performs a television application instruction provided by the television GUI.

Embodiments described herein are provided for illustration only. Equivalent changes or modifications to the embodiments can be made without departing from the scope of the claims defined herein.

What is claimed is:

1. A television system comprising:
a television receiver apparatus comprising:
a television signal receiving unit for receiving a television signal containing television programs;
a first driver for running a first GUI;
a first transceiver for receiving a control signal and transmitting an updating signal; and
a processor for generating the updating signal, and performing a television application instruction provided by the first GUI in response to the control signal;
a touch-controlled device comprising:
a second driver for running a second GUI;
a touch display unit for displaying the second GUI, and generating the control signal in response to a user's touch input to the touch-controlled device via the second GUI; and
a second transceiver for receiving the updating signal and transmitting the control signal, wherein the second driver updates objects of the second GUI in order to match objects of the first GUI according to the updating signal.

2. The television system of claim 1, wherein the objects displayed by the second GUI correspond in amount to the objects displayed by the first GUI.

3. The television system of claim 1, wherein the objects displayed by the second GUI correspond in position to the objects displayed by the first GUI.

4. The television system of claim 1, wherein the objects displayed by the second GUI have icons matching with the objects displayed by the first GUI.

5. The television system of claim 1, wherein the objects displayed by the second GUI correspond in relative size to the objects displayed by the first GUI.

6. The television system of claim 1, wherein the objects displayed by the second GUI correspond in color to the objects displayed by the first GUI.

7. The television system of claim 1, wherein the updating signal updates the second GUI and the first GUI at approximately the same time.

8. The television system of claim 1, wherein the television signal receiving unit receives the television signal from a satellite signal source, a wired signal source, a wireless signal source, or an Internet Protocol television (IPTV) signal source.

9. The television system of claim 1, wherein the television signal receiving unit is a tuner or a decoder.

10. The television system of claim 1, wherein the television application instruction comprises a switch power instruction, a channel selection instruction, a volume tuning instruction, a signal source switching instruction, a mute instruction, an application execution instruction, an application selection instruction, a menu page scrolling instruction, a game execution instruction, an e-book reading instruction, or a fast forward instruction, a rewind instruction, a pause instruction, or a play instruction for a multimedia file.
